(19) United States
(12) Patent Application Publication
(10) Pub. No.: US 2023/0122375 A1
(43) Pub. Date: Apr. 20, 2023

(54) CREAMY SUBSTANCE

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 17/966,995

(22) Filed: Oct. 17, 2022

(30) Foreign Application Priority Data
Oct. 18, 2021 (JP) 2021-170485

(51) Int. Cl. B29C 64/106

(52) U.S. Cl. CPC B29C 64/106; B29K 2003/00; B29K 2033/00

(57) ABSTRACT

The present invention relates to a creamy substance, which is configured to be discharged from a squeezing tool to produce a decorative body-formed toy, and contains a resin and a starch and has transparency.

### CROSS-REFERENCE TO RELATED APPLICATIONS

This application is based on and claims priority under 35 USC 119 from Japanese Patent Application No. 2021-170485 filed on Oct. 18, 2021, the contents of which are incorporated herein by reference.

### TECHNICAL FIELD

The present invention relates to a creamy substance.

### BACKGROUND ART

Conventionally, there has been proposed a toy for producing a pseudo food such as a cake by using a tube filled with a creamy resin. For example, Patent Literature 1 discloses a toy set including a resin tube in which a creamy resin, which is a synthetic resin, is filled in a tube container. A user can enjoy with this toy set to easily form a decoration toy of a pseudo food having high decorativeness as an accessory imitating a food having a beautiful appearance.

Patent Literature 1: JP2010-000152A

### SUMMARY OF INVENTION

The above-described creamy substance, which is a creamy resin, is available in diverse colors, and can form colorful decoration toys having decorativeness. This type of creamy substance may be required to have transparency in order to form decoration toys of more diverse colors.

An object of the present invention is to provide a creamy substance having transparency and excellent formability.

A creamy substance according to an aspect of the present invention is a creamy substance, which is configured to be discharged from a squeezing tool to produce a decorative body-formed toy, and contains a resin and a starch and has transparency.

According to this aspect of the present invention, a creamy substance having transparency and excellent formability can be provided.

### BRIEF DESCRIPTION OF DRAWINGS

FIG. 1 is a front view of a squeezing tool for discharging a creamy substance according to an embodiment.

FIG. 2 is a perspective view illustrating a state in which the creamy substance according to the embodiment is discharged on a decoration toy.

### DESCRIPTION OF EMBODIMENTS

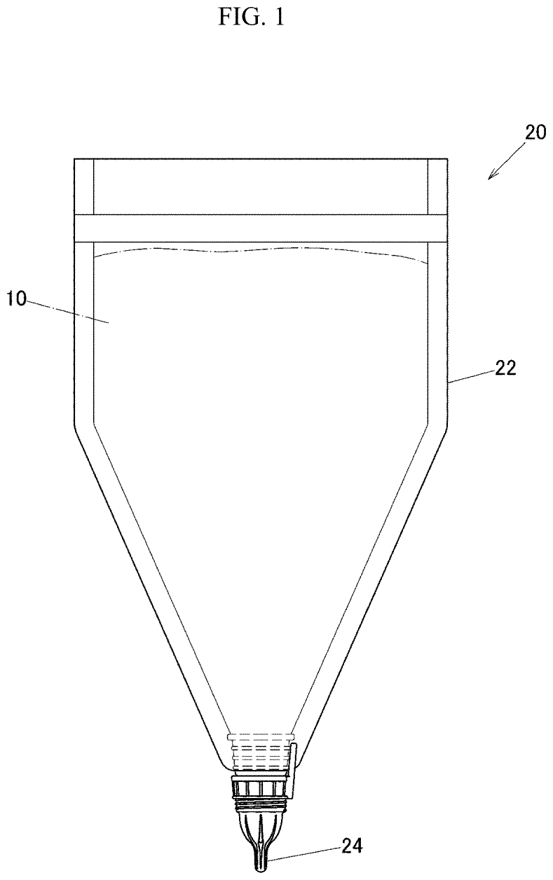

An embodiment of the present invention will be described with reference to the drawings. A creamy substance 10 according to the embodiment may be stored in, for example, a squeezing tool 20 as illustrated in FIG. 1. A container 22 of the squeezing tool 20 may be formed by stacking two flexible sheet members made of a polyvinyl chloride resin or the like and bonding sides of the two sheet members by thermocompression bonding. A rear portion of the container 22 may be closed in a bag shape by bonding the two sheet members by the thermocompression bonding. The creamy substance 10 may be discharged from a discharge port 24 at a tip end of the squeezing tool 20 and placed on a production surface of a decorative body imitating a cake or the like, whereby a decoration toy can be produced.

Here, the creamy substance 10 is prepared by blending a preservative or the like with a synthetic resin such as an acrylic resin, and is solidified when the creamy substance 10 is dried by being exposed to air. Examples of the preservative include phenoxyethanol. Examples of the acrylic resin include a polyacrylic acid polymer. The creamy substance 10 is a creamy resin that can be formed in diverse colors such as white and pink. Further, the creamy substance 10 according to the present embodiment contains starch, preferably potato starch, in a content of, for example, 8.5 to 10 wt % (preferably about 9 wt %) with respect to the total weight of the creamy substance 10, and is made of a translucent resin (a resin having transparency). Here, the term “transparency” includes translucency, and also includes transparency that allows not only recognition of a shape of an object covered with the creamy substance 10 and a shape of an object located on an opposite side with the creamy substance 10 therebetween, but also transmission of light even if the shape cannot be recognized.

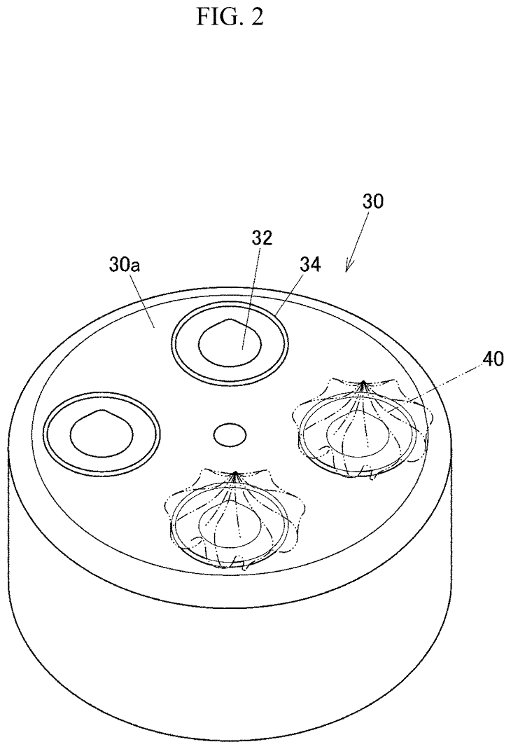

Next, an example in which the creamy substance 10 is discharged and placed on a pedestal 30 of the decoration toy as illustrated in FIG. 2 will be described. The pedestal 30 has a circular shape in a top view, and is formed by injection molding using, for example, a resin material. An upper surface 30a of the pedestal 30 is a production surface on which a decorative body 40 is produced. The creamy substance 10 discharged from the squeezing tool 20 illustrated in FIG. 1 is placed on a decorative body-supporting portion 32 on the production surface to form the decorative body 40, whereby the decoration toy imitating a circular cake can be produced.

In this embodiment, four decorative body-supporting portions 32 are provided at equal intervals on the upper surface 30a of the pedestal 30 so as to protrude in a substantially right cone shape. An annular convex portion 34 is provided on an upper surface of an outer periphery of each of the decorative body-supporting portions 32. The annular convex portion 34 is formed in a circular shape in a top view.

When the creamy substance 10 is placed on the decorative body-supporting portion 32 of the pedestal 30, the creamy substance 10 is supported by the decorative body-supporting portion 32 with good appearance. The annular convex portion 34 can be served as a guide to know a range in which the creamy substance 10 should be placed, and can also prevent the creamy substance 10 from spreading out therefrom so as to make the outer shape clean. The creamy substance 10 placed on all of the decorative body-supporting portions 32 is dried and solidified to form the decorative bodies 40, and the decoration toy is completed.

Here, since the creamy substance 10 according to the present embodiment is translucent, when the creamy substance 10 is placed on the decorative body-supporting portions 32, the decorative body-supporting portion 32 can be visually recognized through the creamy substance 10 (see FIG. 2). Therefore, the creamy substance 10 is easily placed on the decorative body-supporting portion 32 as compared with the case of an opaque creamy sub stance.

Further, since the decorative body 40 formed by drying and solidifying the creamy substance 10 is also translucent, the decorative body-supporting portion 32 and the annular convex portion 34 covered with the decorative body 40 can be visually recognized through the decorative body 40. Therefore, it is possible to form a visually new decorative body-formed toy. The decoration toy may be formed by combining the creamy substance 10 according to the present embodiment with a conventional opaque creamy substance.

Further, since the creamy substance 10 contains a small amount of starch (9 wt % of potato starch in the present embodiment), the creamy substance 10 discharged from the squeezing tool 20 becomes soft due to gelatinization (α-rization) of starch as compared with a conventional creamy substance that does not contain starch. Therefore, the creamy substance 10 is easily discharged from the squeezing tool 20, and is also excellent in formability when the creamy substance 10 is placed on the decorative body-supporting portion 32.

On the other hand, since starch is contained in a small amount (9 wt % of potato starch in the present embodiment), the decorative body 40 formed by drying and solidifying the creamy substance 10 becomes hard due to retrogradation (β-rization) of starch as compared with a decorative body formed by drying and solidifying a conventional creamy substance. Therefore, the stability and durability of the decoration toy formed by the decorative body 40 can be improved.

As described above, since the creamy substance 10 according to the embodiment contains a small amount of starch, the creamy substance 10 has transparency and excellent moldability. Therefore, it is possible to easily form decoration toys of more diverse colors as compared with the decoration toy formed of a conventional opaque creamy substance, and it is possible to allow a user to play with the decoration toy without getting bored.

According to the embodiment of the present invention as described above, a creamy substance of the following aspects can be provided.

A creamy substance according to a first aspect of the present invention is a creamy substance, which is configured to be discharged from a squeezing tool to produce a decoration toy, and contains a resin and a starch and has transparency.

According to this configuration, the creamy substance having transparency and excellent formability can be realized as compared with a conventional opaque creamy substance containing no starch.

In the creamy substance according to a second aspect, the starch is a potato starch.

According to this configuration, since the potato starch has a low gelatinization temperature and is excellent in transparency as compared with other starches, a specific material for effectively realizing the creamy substance having the transparency and the excellent formability can be provided.

The creamy substance according to a third aspect contains the potato starch in a range of 8.5 to 10 wt % with respect to a total weight of the creamy substance.

In the case where the content of the potato starch is too small (less than 8.5 wt %), it may be difficult to maintain the shape, and formability of the creamy substance tends to be low. On the other hand, in the case where the content of the potato starch is too large (more than 10 wt %), the creamy substance tends to be excessively hard after being dried and solidified. According to the above configuration, it is possible to provide a specific blending ratio of the potato starch for effectively realizing the creamy substance having transparency and excellent formability.

The embodiments described above have been presented by way of example only, and are not intended to limit the scope of the inventions. These novel embodiments can be implemented in various other forms, and various omissions, replacements, and modifications can be made without departing from the gist of the invention. These embodiments and a modification thereof are included in the scope of the invention or the gist thereof, and are included in a scope equivalent to the invention described in the claims.

### EXAMPLE

In the Example, a creamy substance containing a small amount of potato starch was produced. As a synthetic resin, a polyacrylic acid polymer (specifically, a polyacrylic acid aqueous solution obtained by adding purified water and a small amount of a surfactant to polyacrylic acid) was used. Further, a small amount of phenoxyethanol was added as a preservative. Bending ratios of the polyacrylic acid polymer, the potato starch, and the phenoxyethanol are shown in Table 1. In Table 1, the unit of the blending ratio of each raw material is wt %.

TABLE 1

| Raw Material | Blending ratio (wt %) |
|---|---|
| Polyacrylic acid polymer | 90.867 |
| Potato starch | 9.087 |
| Phenoxyethanol | 0.046 |
| (Total) | 100.0 |

It can be confirmed that the produced creamy substance was translucent when the transparency of the produced creamy substance was visually observed. Further, it can be confirmed that the product obtained by drying and solidifying the creamy substance was also translucent.

Further, when formability of the produced creamy substance was confirmed by discharging the creamy substance onto a pedestal of the decoration toy, it can be confirmed that the produced creamy substance was soft and excellent in formability as compared with a conventional opaque creamy substance containing no starch.

### REFERENCE NUMERALS AND SIGNS

10 Creamy substance

20 Squeezing tool

22 Container

24 Discharge port

30 Pedestal

30a Upper surface

32 Decorative body-supporting portion

34 Annular convex portion

40 Decorative body

What is claimed is:

1. A creamy substance configured to be discharged from a squeezing tool to produce a decoration toy, the creamy substance comprising a resin and a starch, and having transparency.

2. The creamy substance according to claim 1, wherein the starch is a potato starch.

3. The creamy substance according to claim 2, wherein the potato starch is contained in a range of 8.5 to 10 wt % with respect to a total weight of the creamy substance.

4. The creamy substance according to claim 1, wherein the resin comprises an acrylic resin.

5. The creamy substance according to claim 4, wherein the acrylic resin is a polyacrylic acid polymer.
